(19) United States
(12) Patent Application Publication
(10) Pub. No.: US 2026/0265932 A1
(43) Pub. Date: Sep. 10, 2026

(54) SYSTEM AND METHOD FOR PRODUCTION OF ELECTRICTY USING AN ELECTROLYSIS APPARATUS

(71) Applicants: TERESITA AMPONIN CANUTO, Mission Hills, CA (US); Dominic Amponin Canuto, Mission Hills, CA (US)

(72) Inventors: TERESITA AMPONIN CANUTO, Mission Hills, CA (US); Dominic Amponin Canuto, Mission Hills, CA (US)

(21) Appl. No.: 18/831,515

(22) Filed: Mar. 10, 2025

(51) Int. Cl. C25B 11/043; C25B 1/04; C25B 5/00; C25B 9/60; C25B 15/02

(52) U.S. Cl. CPC C25B 11/043; C25B 1/04; C25B 5/00; C25B 9/60; C25B 15/02

(57) ABSTRACT

An electrolysis apparatus is presented. Anode and cathode catalysts or carbon electrodes are submerged in saltwater in a basin with the goal of extracting hydrogen gas, which is a renewable source of energy. The basin is metallic and includes rubber on the outside of the basin to handle high temperatures. A battery connected to the basin serves as a power supply and provides direct electric current to cause the breakdown of the element via electricity to produce hydrogen gas and direct the hydrogen gas to other items as a source of electricity.

### BACKGROUND OF THE INVENTION

The present invention relates to an inexpensive method to produce an energy or electricity with the use of water (H2O) and salt (NaCl) or saltwater. Due to high cost of electricity in the urban land living, thereby raising the desirability of the creation of an affordable, inexpensive electricity that people can use and benefited from it because the created invention is assured to save a lot of money from the use of the portable apparatus unit that created electricity that lessens the expense in electricity.

The present invention also relates to offset the rising greenhouse gas concentration in the atmosphere that affect the global temperature and caused the warming of the planet. The economical electrolysis apparatus that capitalize on saltwater and carbon electrodes does not requires costly processing when converting such materials to produce electricity.

### BRIEF SUMMARY OF THE INVENTION

It is an object of the present invention to provide an economical and requires less effort to produce an electricity that capitalize on water (H20), salt (NaCl) and carbon electrodes. The carbon electrodes are made up of mantle peridotite carbon mineralization based activated carbon. Graphite electrodes can also be used as the catalyst in the electrolysis apparatus. An anode and cathode catalysts or carbon electrodes submerged in the saltwater extract hydrogen from the water with addition of salt can produce hydrogen renewable source of electricity.

### BRIEF DESCRIPTION OF THE FIGURES

FIG. 1 shows a representative view of components of the portable electrolysis apparatus.

FIG. 2 shows a representative view of a portable electrolysis apparatus connected to a lightbulb and a method for electrolysis to occur.

FIG. 3 shows a representative view of saltwater being added to the portable electrolysis apparatus.

FIG. 4 shows a representative view of the portable electrolysis apparatus.

FIG. 5 shows multiple types of lights that can be connected to the portable electrolysis apparatus.

FIG. 6 shows additional lights that can be connected to the portable electrolysis apparatus.

FIG. 7 shows a representative view of types of chandeliers and wall lights.

FIG. 8 shows a representative view of the electrolysis apparatus.

FIG. 9 shows a representative view of neon lights.

FIG. 10 shows a representative view of the electrolysis apparatus in connection with Pulse Radar and Continuous Wave Radar

FIG. 11 shows a representative view of the electrolysis apparatus in connection with a Doppler Radar and the Synthetic Aperture Radar.

FIG. 12 shows a representative view of the electrolysis apparatus used along with various electrical appliances.

FIG. 13 shows a representative view of frozen saltwater being added to a portable electrolysis apparatus.

FIG. 14 shows a representative view of the electrolysis apparatus being used with a greenhouse.

### DETAILED DESCRIPTION OF THE INVENTION

A carbon electrodes used in oxygen reduction of saltwater to generated hydrogen (H+) using the electrolytic reductions water splitting method or electrolysis. A zinc-carbon battery (ex. National hyper battery) is the source of direct electric current (DC) responsible for the breakdown of elements via electricity. The zinc-carbon battery is a dry cell that provides direct electric current that produces a voltage of about 1.5 volts, the decomposition potential.

A voltage regulator is designed and added to the circuit to keep a constant output of voltage even when the input voltage changes. The dry cell has a zinc-anode and carbon rod of positive side ends of zinc-anode and carbon rod of positive polarity. The cathode that collects the current. Attached at both side ends of zinc-anode and cathode of the battery are the anode (positive, red wire) and the cathode (negative, black wire) to power the electrolytic reductions. The red (positive) and negative (black) wires are clipped to each piece of carbon electrodes that are submerged in the saltwater inside the apparatus.

The electrolysis efficiency apparatus has a basin for storage of the saltwater to be used in electrolysis. The apparatus is made up of aluminum metal case. Inside the apparatus is made up of acrylic plastic or plexiglass covered outside with silicon rubber that can handle heat up to 450 degrees F.

The apparatus may be called “electrolysis efficiency basin.” Carbon electrodes may be submerged in saltwater attached to the wires of the battery. The carbon electrodes are made of either mantle peridotite based-activated carbon or from graphite carbon. With the electricity or electrical current passing into the saltwater and carbon electrodes hydrogen ions flow to the cathode to combine with electrons to produce hydrogen gas in a reduction reaction, while the OH-ion gas flow to the anode to release electrons and H+to produce oxygen gas in an oxidation reaction. On the other hand, the sodium chloride (NaCl) dissolved in water, the anode oxidizes chloride ions (Cl—) to chlorine gas (C12). At the cathode instead of the sodium ions being reduced to sodium metal, water molecules are reduced to hydroxide ions (OH—) and hydrogen gas (H2). The overall result of chlorine gas, hydrogen and aqueous of sodium hydroxide (NaOH) solution.

The electrical wires of anode and cathode, the on-off switch of electricity of the basin of the electrolysis efficiency basin where electrodes submerged in a solution or saltwater has a copper metal (cathode) used to hold ionized and dilute NaCl in water to extract hydrogen gas.

### BRIEF DESCRIPTION OF THE DRAWINGS

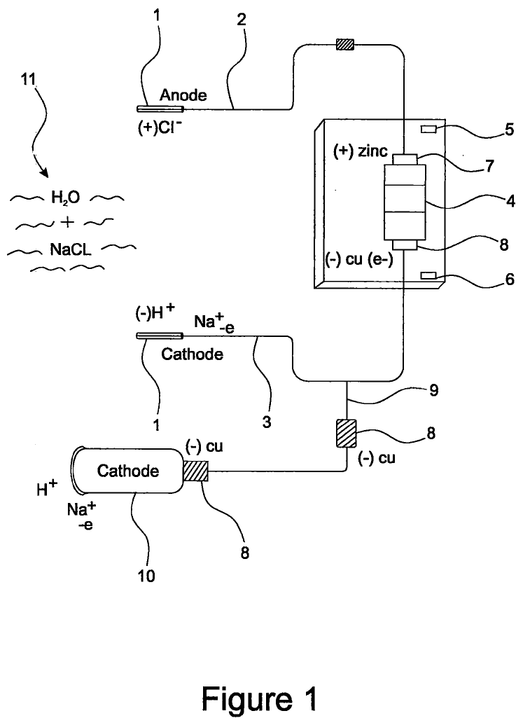

FIG. 1 1. anode, cathode
2. positive (+), red wire (anode)
3. negative (−), black wire
4. battery (power supply)
5. on-off switch of electricity
6. voltage regulator
7. positive (+), anode
8. negative (−), cathode
9. wire
10. cathode
11. water mixed with salt (saltwater)

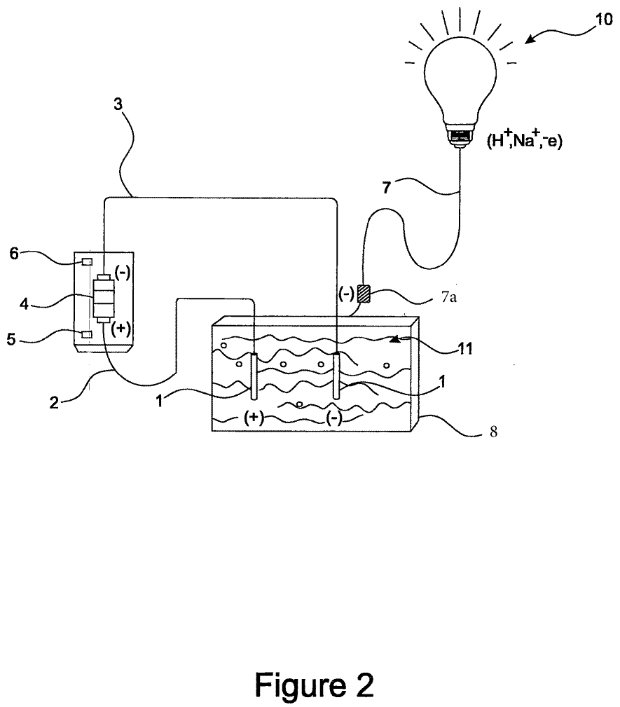

FIG. 2 1. cathode, anode
2. positive (+), red wire
3. negative (−), black wire
4. battery (power supply)
5. on-off switch of electricity
6. voltage regulator
7. wire
7a. copper metal (cathode)
8 electrolysis apparatus
10. light bulb

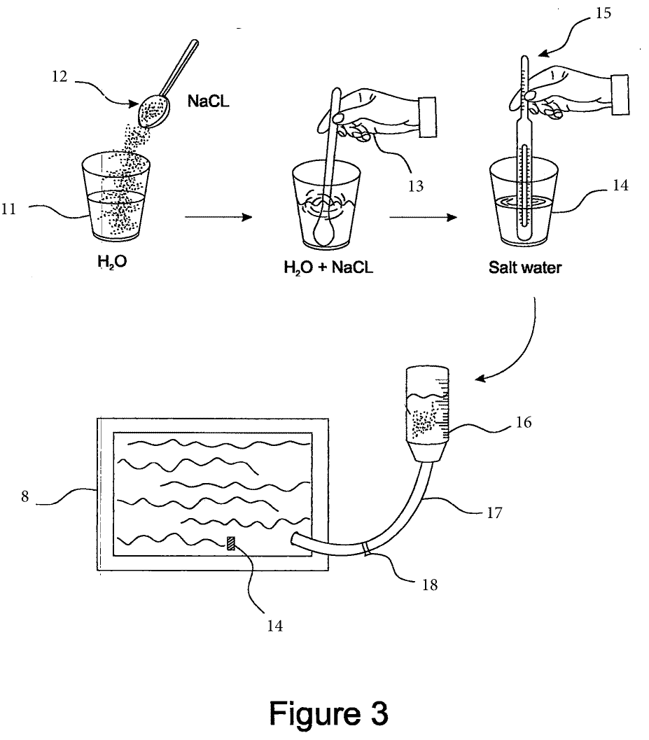

FIG. 3 11 Glass with water (H20)
12 salt (NaCl)
13 H20 and NaCl (mixed)
14 saltwater
15 salt tester
16 cylinder tube
17 small host that connects the cylinder tube to the apparatus
18 on-off lock
14 saltwater
8 electrolysis apparatus

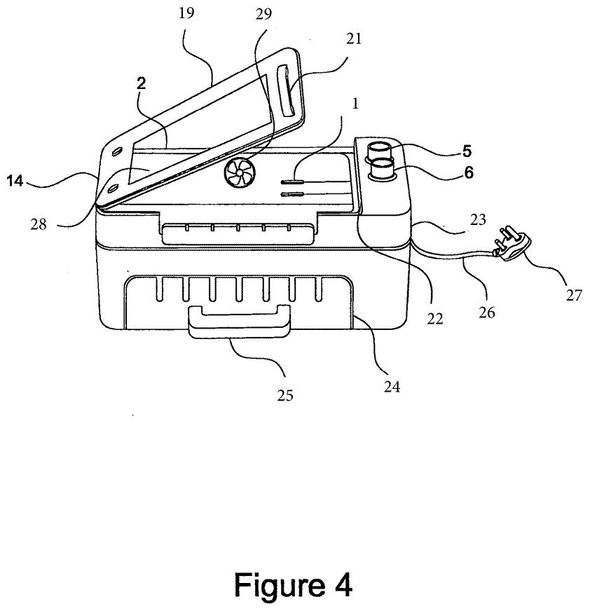

FIG. 4 19 lid of the apparatus
1 anode, cathode (electrodes)
21 handle of the lid
5. on-off switch of electricity
6. voltage regulator
22 silicon rubber
23 aluminum metal body of apparatus
24 tray (holds the brine)
25 handle of the tray
26 electric wire
27 electric socket
28 glass lid
29 small fan

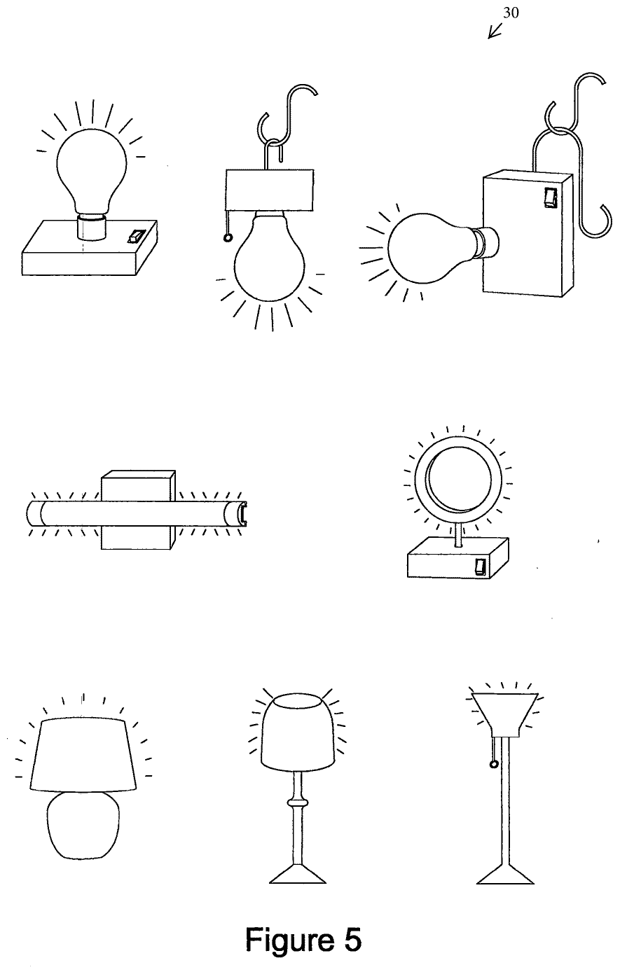

FIG. 5 30 types of light, lamps that use the apparatus

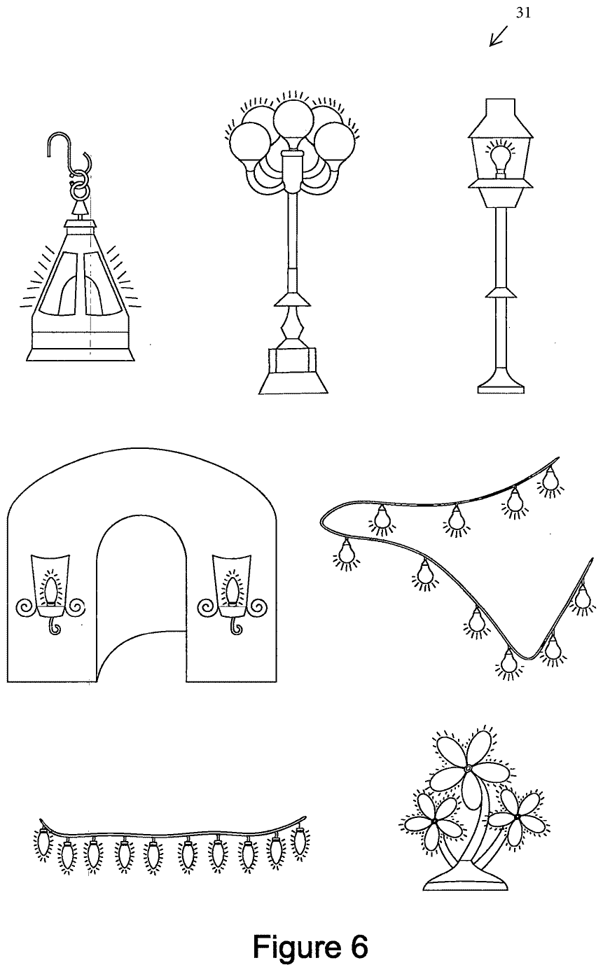

FIG. 6 31 types of outdoor lights (garden lamp, wall lamp, table décor light, wall lamp)(that use the apparatus as source of electricity)

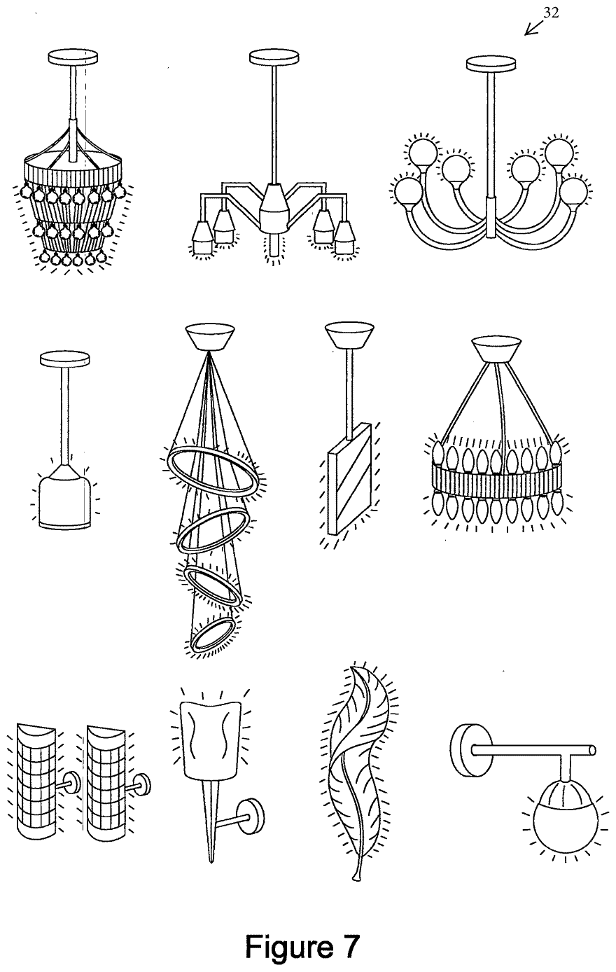

FIG. 7 32 types of chandeliers, sconce, wall light (that use the apparatus as source of electricity)

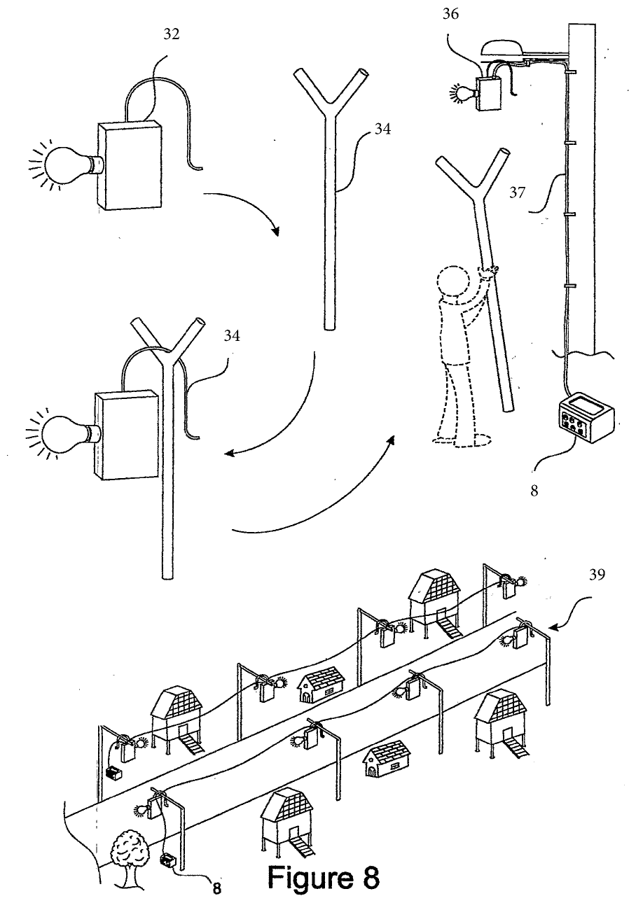

FIG. 8 33 light bulb
34 hook
35 light bulb in hook
36 light post with light bulb
37 electric wire
8 electrolysis apparatus
39 light posts installed in the street of community
8 electrolysis apparatus connected to electric wire in the light posts as source of electricity

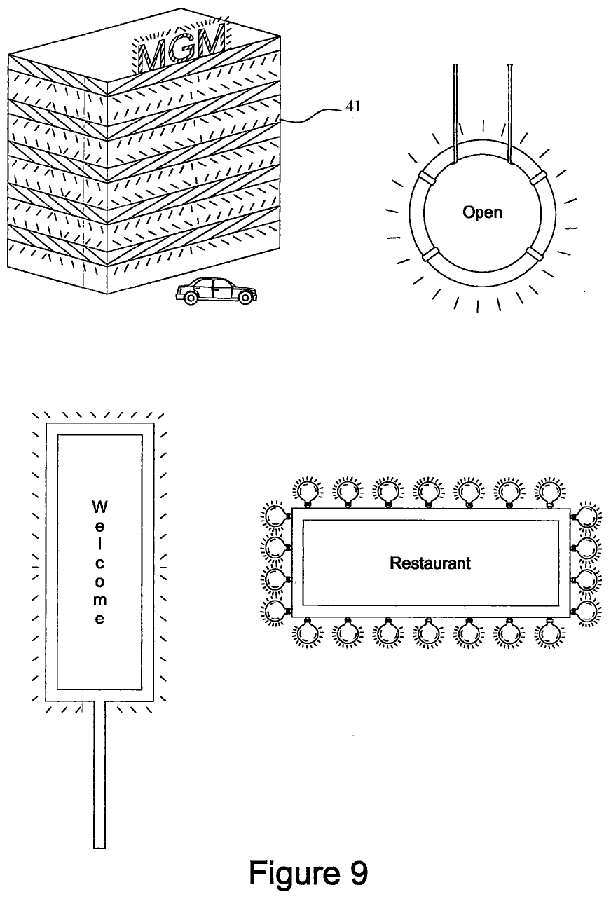

FIG. 9 41 Neon light, signage light (that use the apparatus as source of electricity)

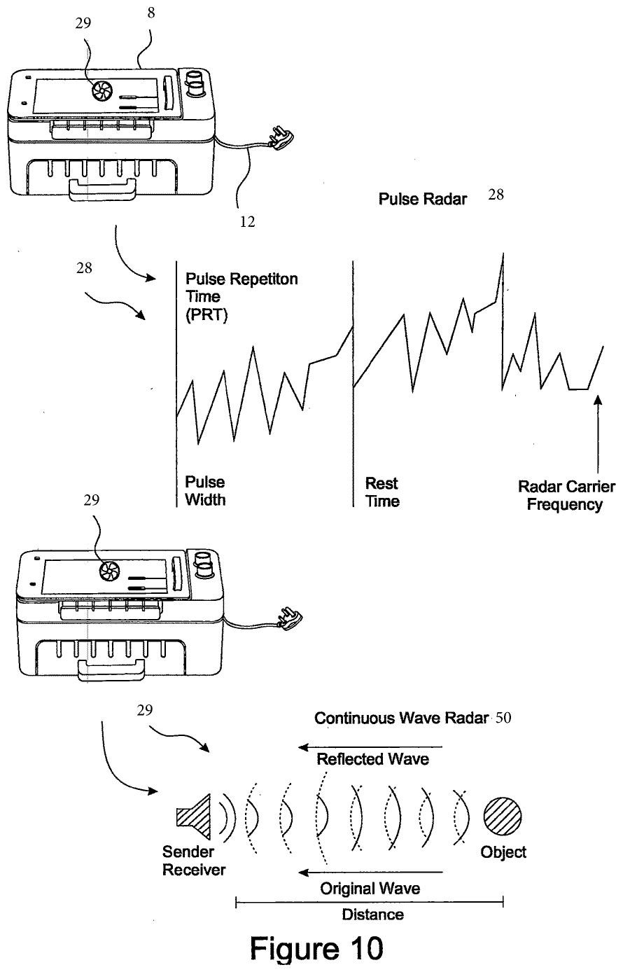

FIG. 10 8 electrolysis efficiency basin or apparatus
26 electrical wire of apparatus with a socket
28 Pulse Radar (that uses the apparatus as source of electricity)
50 Continuous Wave Radar (that uses the apparatus as source of electricity)

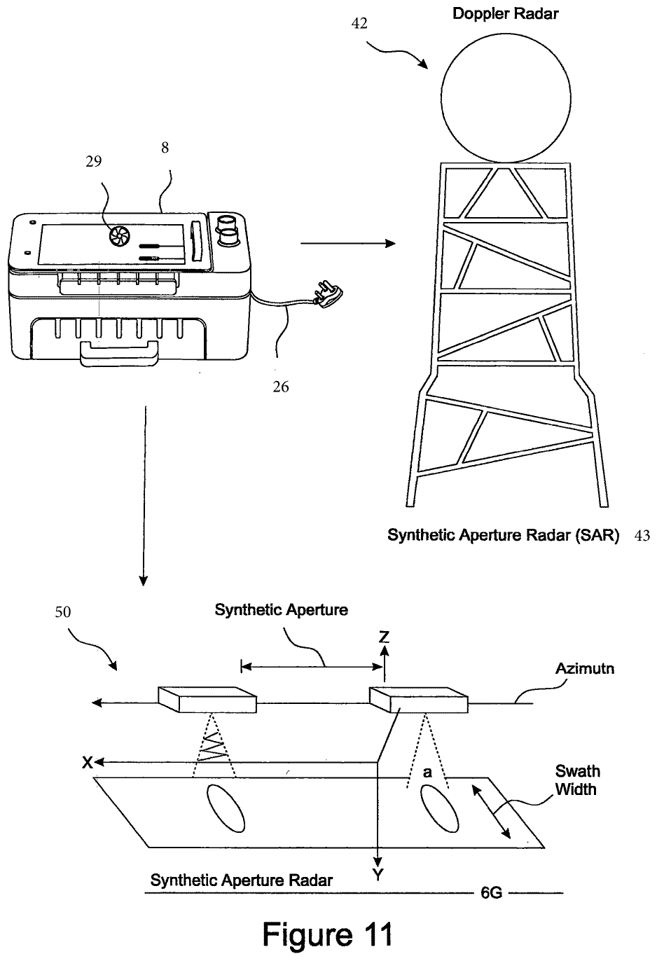

FIG. 11 8 electrolysis efficiency basin or apparatus
26 electrical wire of apparatus with a socket
42 Doppler Radar (that uses the apparatus as source of electricity)
43 Synthetic Aperture Radar (that uses the apparatus as source of electricity)

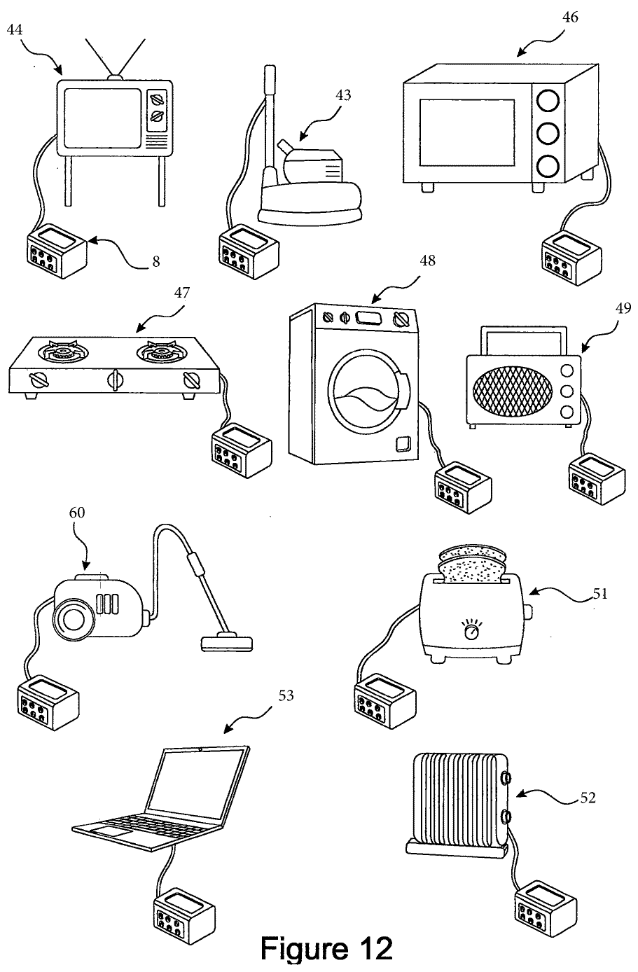

FIG. 12 8 electrolysis efficiency basin or apparatus
44 television (that uses the apparatus as source of electricity)
45 floor polisher
46 microwave
47 stove
48 washing machine/dryer
49 radio
60 vacuum cleaner
51 bread toaster
52 bread toaster
53 laptop computer

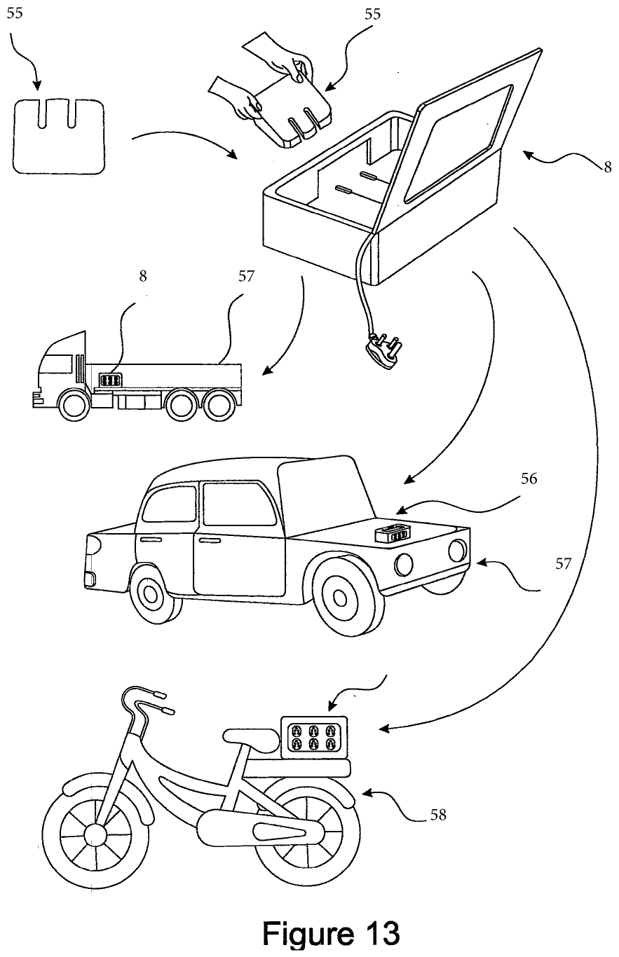

FIG. 13 55 frozen saltwater (H20+NaCl)
55 frozen saltwater being installed to the apparatus
8 electrolysis efficiency apparatus
56 apparatus provides electrical energy to electric vehicle
57 electric vehicle
58 apparatus provides electrical energy to electric bike

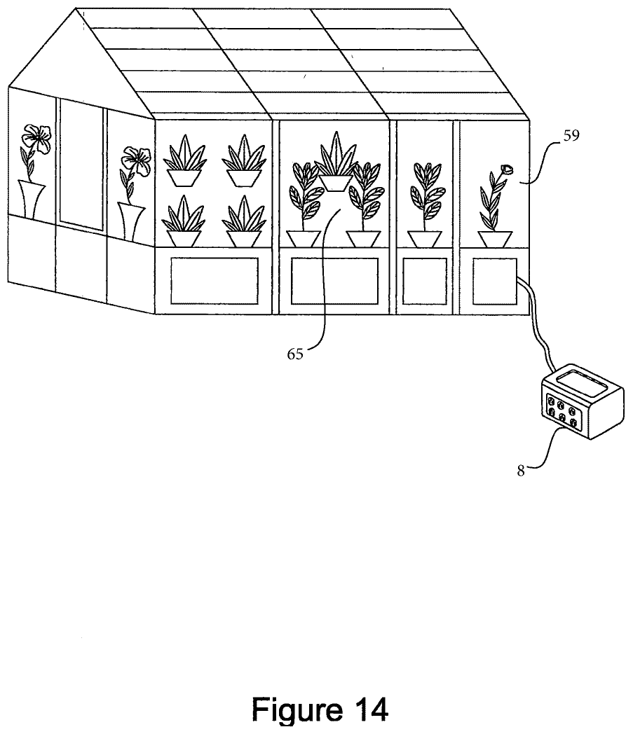

FIG. 14 8 electrolysis efficiency apparatus (provides heating and cooling system for the greenhouse)
59 green house edifice
65 plants

The invention claimed is:

1. A method comprising:
providing a portable electrolysis apparatus comprising:
a basin covered on the outside with silicone rubber, wherein the basin comprises:
saltwater;
carbon electrodes, wherein the carbon electrodes are submerged in the saltwater and wherein the carbon electrodes are clipped in place inside of the basin;
anodes;
cathodes, wherein the anodes and cathodes are submerged in the saltwater;
a voltage regulator;
a battery;
powering on the battery causing an electrolytic reaction to occur such that the anodes oxidize chloride ions from the saltwater to chorine gas and at the cathode, water molecules from the saltwater are reduced to hydroxide ions and hydrogen gas;
extracting the hydrogen gas obtained through the electrolytic reaction; and
using the hydrogen gas as a source of energy.

2. The method of claim 1, wherein the voltage regulator keeps a constant output of voltage even when input voltage changes.

3. The method of claim 1, comprising, connecting the portable electrolysis apparatus to a light.
